(19) United States
(12) Patent Application Publication
(10) Pub. No.: US 2025/0252431 A1
(43) Pub. Date: Aug. 7, 2025

(54) INTERACTIVE LOYALTY PROGRAM COMPUTING SYSTEMS AND METHODS

(71) Applicants: Gunter Pfau, Philadelphia, PA (US); Aaron McLean, Chestertown, MD (US); Navid Safabakhsh, Laguna Beach, CA (US)

(72) Inventors: Gunter Pfau, Philadelphia, PA (US); Aaron McLean, Chestertown, MD (US); Navid Safabakhsh, Laguna Beach, CA (US)

(21) Appl. No.: 19/043,995

(22) Filed: Feb. 3, 2025

Related U.S. Application Data
(60) Provisional application No. 63/548,569, filed on Feb. 1, 2024.

(51) Int. Cl. G06Q 20/38; G06Q 20/20; G06Q 30/0207; G06Q 30/0238

(52) U.S. Cl. CPC G06Q 20/387; G06Q 20/204; G06Q 30/0224; G06Q 30/0238

(57) ABSTRACT

Systems and methods for modifying transaction data at a remote point-of-sale device (POS) are disclosed. A system in accordance with the present disclosure includes at least one processor programmed to receive, from a POS device, an offer request message including a unique consumer identifier and transaction data. In response to receiving the offer request message, the processor is programmed to retrieve an offer associated with the unique consumer identifier and cause to be displayed, on a user interface of a remote computing device, the offer. The at least one processor is further programmed to receive, from the POS device, updated transaction data, the updated transaction data including a second transaction amount that is greater than the first transaction amount and in response to receiving the updated transaction data, transmit a modification message cause the POS device to modify the transaction in accordance with the at least one offer.

### CROSS-REFERENCE TO RELATED APPLICATION

This application claims the benefit of priority to U.S. Provisional Patent Application No. 63/548,569, filed Feb. 1, 2024, entitled “Loyalty Display at Retail Checkout”, the entire contents and disclosure of which is hereby incorporated by reference in its entirety.

### FIELD OF THE DISCLOSURE

The present disclosure generally relates to loyalty program computing systems, and more particularly, to computer-based systems and methods for tracking and modifying transaction data at remote point-of-sale devices.

### BACKGROUND

Currently, billions of transactions are performed each month at physical merchants. Currently there is no automated, flexible, and secure mechanism to track and modify transaction data at point-of-sale devices on a consumer basis. More particularly, there is currently no automated way to collect transaction data for a particular consumer and automatically apply offers that may be available to a particular consumer to a transaction being conducted by the consumer at a remote point-of-sale device. For example, a particular merchant may be able to apply discounts available to all customers at the particular merchant using conventional systems and methods, but the particular merchant is not able to automatically apply discounts generated and/or made available for a particular customer. Further, current point-of-sale systems typically do not include a screen in which consumers can view relevant information related to a transaction, including but not limited to, available offers, loyalty points, and the like. Further, retail store associates do not have any devices or displays directly facing them which can display information regarding the customer that is standing directly across from them on the other side of the counter.

Therefore, an automatic, flexible, and secure mechanism for associating transactions with a particular consumer so that relevant information may be collected, displayed, and applied to a transaction is desirable. Conventional techniques may include other drawbacks, inefficiencies, ineffectiveness, and/or encumbrances, as well.

### BRIEF DESCRIPTION

In one aspect, a loyalty program computing system is disclosed. The loyalty program computing system comprises at least one processor and a memory device. The at least one processor is programmed to receive, from a point-of-sale (POS) device during a transaction, an offer request message, the offer request message including a unique consumer identifier and transaction data, the transaction data including a first transaction amount. The at least one processor is further programmed to in response to receiving the offer request message, retrieve at least one offer associated with the unique consumer identifier and cause to be displayed, on a user interface of a remote computing device, the at least one offer. The at least one processor is further programmed to receive, from the POS device, updated transaction data, the updated transaction data including a second transaction amount that is greater than the first transaction amount and in response to receiving the updated transaction data, transmit, to the POS device, a modification message, the modification message causing the POS device to modify the transaction in accordance with the at least one offer.

In another aspect, a computer-implemented method for implementing a loyalty program is disclosed. The computer-implemented method comprises receiving, from the POS device during a transaction, an offer request message, the offer request message including a unique consumer identifier and transaction data, the transaction data including a first transaction amount. The computer-implemented method further comprises in response to receiving the offer request message, retrieving at least one offer associated with the unique consumer identifier and causing to be displayed, on a user interface of a remote computing device, the at least one offer. The computer-implemented method further comprises receiving, from the POS device, updated transaction data, the updated transaction data including a second transaction amount that is greater than the first transaction amount and in response to receiving the updated transaction data, transmit, to the POS device, a modification message, the modification message causing the POS device to modify the transaction in accordance with the at least one offer.

In yet another aspect, at least one non-transitory computer-readable medium comprising instructions stored thereon for implementing a loyalty program is disclosed. The instructions are executable by at least one processor to cause the at least one processor to perform steps including receive, from a point-of-sale (POS) device during a transaction, an offer request message, the offer request message including a unique consumer identifier and transaction data, the transaction data including a first transaction amount. The instructions further cause the at least one processor to in response to receiving the offer request message, retrieve at least one offer associated with the unique consumer identifier and cause to be displayed, on a user interface of a remote computing device, the at least one offer. The instructions further cause the at least one processor to receive, from the POS device, updated transaction data, the updated transaction data including a second transaction amount that is greater than the first transaction amount and in response to receiving the updated transaction data, transmit, to the POS device, a modification message, the modification message causing the POS device to modify the transaction in accordance with the at least one offer.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

FIGS. 1-12 show example embodiments of the methods and systems described herein.

FIG. 1 is a diagram of a pin pad credit card machine;

FIG. 2A is a diagram of a customer facing view of a dual-display computing device in accordance with an embodiment of the present disclosure.

FIG. 2B is a diagram of a retailer facing view of the dual-display computing device of FIG. 2A in accordance with an embodiment of the present disclosure.

FIG. 2C is a diagram of a side view of the dual-display computing device of FIG. 2A in accordance with an embodiment of the present disclosure.

FIG. 3 is a block diagram of an interactive loyalty program system in accordance with an embodiment of the present disclosure.

FIG. 4 is a block diagram of a loyalty program computing device that may be used in the computer system shown in FIG. 3 in accordance with an embodiment of the present disclosure.

FIG. 5 is a block diagram of a server computing device that may be used in the computer system shown in FIG. 3 in accordance with an embodiment of the present disclosure.

FIG. 6 is a block diagram of an exemplary user computing device that may be used in the computer system shown in FIG. 3 in accordance with an embodiment of the present disclosure.

FIG. 7 is a protocol diagram that depicts a protocol sequence for associating a transaction with a unique consumer identifier and applying a reward to the transaction in accordance with an embodiment of the present disclosure.

FIG. 8 is a flow diagram illustrating a process of an interactive loyalty program in accordance with an embodiment of the present disclosure.

FIG. 9 illustrates a user interface for a customer computing device during a transaction in accordance with an embodiment of the present disclosure.

FIG. 10 illustrates another user interface for a customer computing device during a transaction in accordance with an embodiment of the present disclosure.

FIG. 11 illustrates a user interface for a retailer computing device during a transaction in accordance with an embodiment of the present disclosure.

FIG. 12 illustrates a user interface for a point-of-sale device during a transaction in accordance with an embodiment of the present disclosure.

### DETAILED DESCRIPTION OF THE DISCLOSURE

The following detailed description illustrates embodiments of the disclosure by way of example and not by way of limitation. The description enables one skilled in the art to make and use the disclosure, describes several embodiments, adaptations, variations, alternatives, and uses of the disclosure, including what is presently believed to be the best mode of carrying out the disclosure.

The technical problems addressed by the systems and methods of the disclosure include at least one of: (i) inability to link a particular consumer to a transaction at a point-of-sale (POS) device; (ii) inability to automatically modify a transaction at a POS device in accordance with third-party loyalty host offers automatically and in real-time; (iii) loyalty host programs having limited access to transaction data associated with particular users; and (iv) inability or very limited ability for loyalty host programs to communicate with POS devices.

The systems and methods of the disclosure may be implemented using computer programming or engineering techniques including computer software, firmware, hardware, or any combination or subset thereof, wherein the technical effects may be achieved by steps including one or more of

In some embodiments, a computer program is provided, and the program is embodied on a computer-readable medium. In an example embodiment, the system may be executed on a single computer system, without requiring a connection to a server computer. In a further example embodiment, the system may be run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Apple Inc. located in Cupertino, CA). In yet a further embodiment, the system is run on a Mac OS® environment (Mac OS is a registered trademark of Apple Inc. located in Cupertino, CA). \The application is flexible and designed to run in various different environments without compromising any major functionality. In some embodiments, the system includes multiple components distributed among a plurality of computing devices. One or more components are in the form of computer-executable instructions embodied in a computer-readable medium. The systems and processes are not limited to the specific embodiments described herein. In addition, components of each system and each process can be practiced independently and separately from other components and processes described herein. Each component and process can also be used in combination with other assembly packages and processes.

In some embodiments, a computer program is provided, and the program is embodied on a computer-readable medium and utilizes a Structured Query Language (SQL) with a client user interface front-end for administration and a web interface for standard user input and reports. In another embodiment, the system is web enabled and is run on a business entity intranet. In yet another embodiment, the system is fully accessed by individuals having an authorized access outside the firewall of the business-entity through the Internet. In a further embodiment, the system is being run in a Windows® environment (Windows is a registered trademark of Microsoft Corporation, Redmond, Washington). The application is flexible and designed to run in various different environments without compromising any major functionality.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

The term “database”, as used herein, may refer to either a body of data, a relational database management system (RDBMS), or to both. A database may include any collection of data including hierarchical databases, relational databases, flat file databases, object-relational databases, object-oriented databases, and any other structured collection of records or data that is stored in a computer system. The above examples are for example only, and thus, are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the system and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

The term “processor”, as used herein, may refer to central processing units, microprocessors, microcontrollers, reduced instruction set circuits (RISC), application specific integrated circuits (ASIC), logic circuits, and any other circuit or processor capable of executing the functions described herein.

The terms “software” and “firmware”, as used herein, are interchangeable, and include any computer program stored in memory for execution by a processor, including RAM memory, ROM memory, EPROM memory, EEPROM memory, and non-volatile RAM (NVRAM) memory. The above memory types are for example only, and are thus not limiting as to the types of memory usable for storage of a computer program.

The term “app,” as used herein, may refer generally to a software application installed and downloaded on a user computing device and executed to provide an interactive graphical user interface at the user computing device. An app associated with the computer system, as described herein, may be understood to be maintained by the computer system and/or one or more components thereof. Accordingly, a “maintaining party” of the app may be understood to be responsible for any functionality of the app and may be considered to instruct other parties/components to perform such functions via the app.

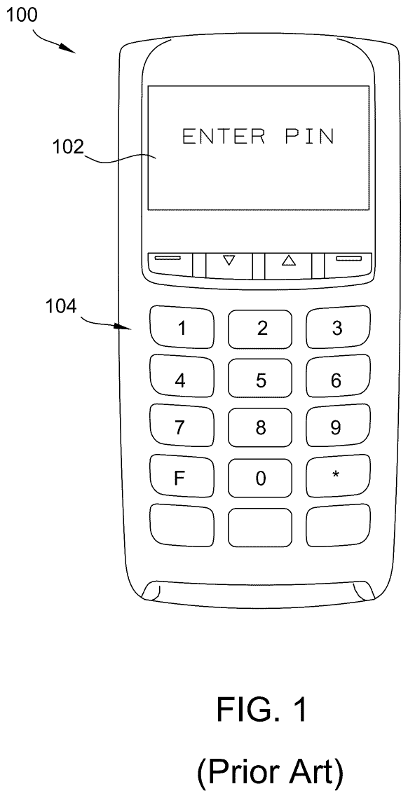

FIG. 1 is a diagram of a credit card reader 100 currently found at retail checkout locations. Credit card readers, such as credit card reader 100 shown in FIG. 1, are connected to point-of-sale systems. Credit card reader 100 includes a small screen 102 and a pin pad 104. Pin pad 104 enables retail customers to punch in certain information, including but not limited to, a phone number, a security code for a credit or debit card, a zip code, and the like. However, pin pads of credit card readers typically have very small buttons which are difficult for consumers to push, often have to be pushed several times for a single input to register with the credit card reader, and often fail. Further, screens of credit card readers are typically very small and hard for retail customers to read, have very limited ability do display information to a consumer, and very limited ability for user interaction. Further, retail store associates who stand behind the checkout counter are typically unable to see any messages or graphics displayed on the small screen of the credit card reader, and therefore lack knowledge about what the consumer is seeing on the screen of the credit card reader. In fact, retail store associates do not have any devices or displays directly facing them which can display information regarding the retail customer that is standing directly across from them on the other side of the counter. Further, during a transaction, a retail store associate does not know whether the customer signed up for a loyalty program or if there was an incremental increase in the purchase behavior of the customer (e.g., the customer purchased more than the customer typically purchases, the customer added one or more additional items to the transaction that the customer was initially not planning to purchase, etc.). Therefore, systems and methods addressing the foregoing issues are desirable.

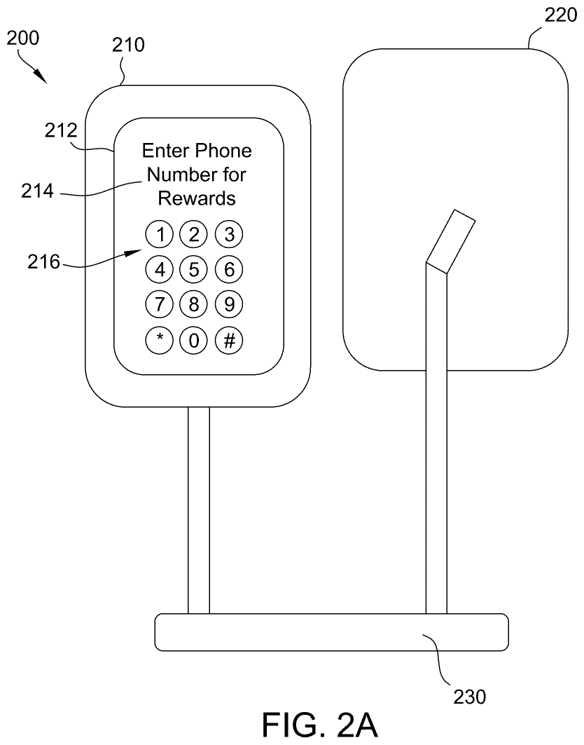

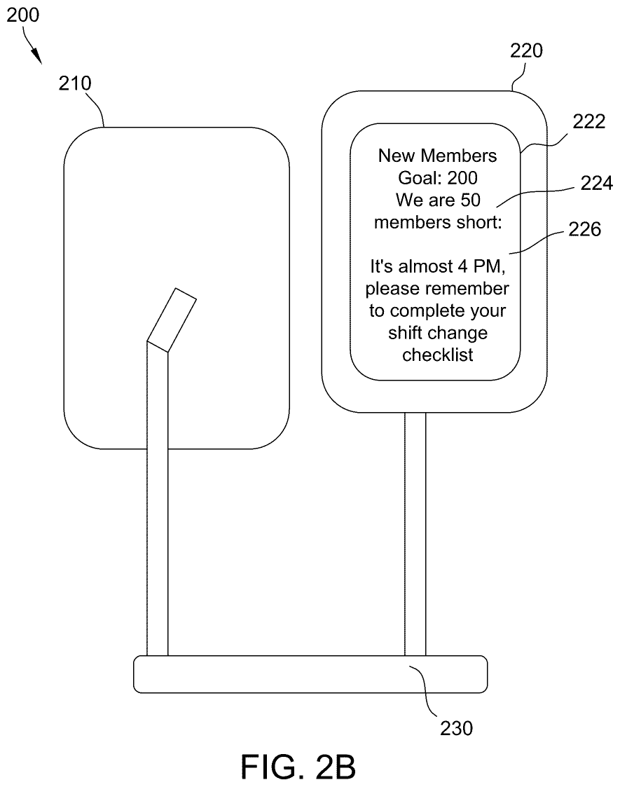

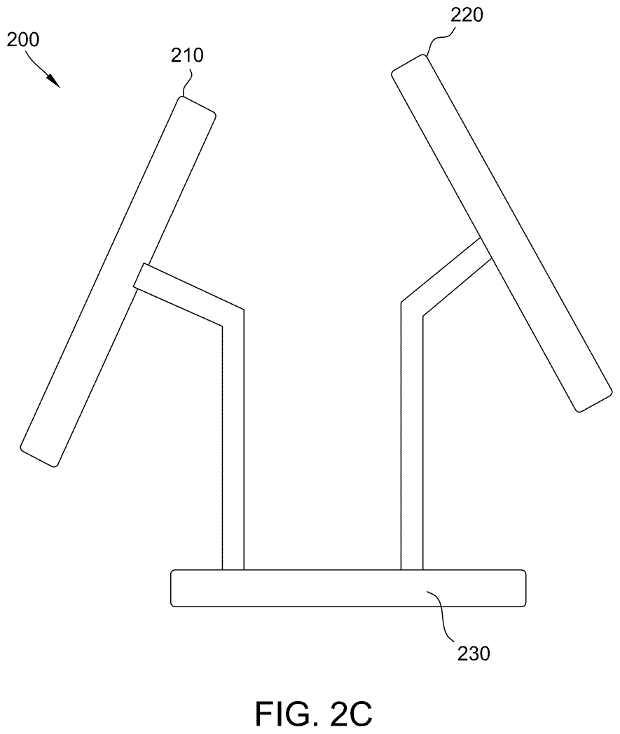

FIG. 2A, FIG. 2B, and FIG. 2C are schematic diagrams of a dual display device 200 in accordance with an embodiment of the present disclosure. Dual display device 200 includes a first computing device 210 and a second computing device 220. First computing device includes a first user interface 212 and second computing device includes a second user interface 222. In one embodiment, first computing device 210 is customer-facing and second computing device 220 is retailer-facing. More particularly, first computing device 210 may face an area in which customers may access first user interface 212 and second computing device 220 may face an area in which retail workers may access second user interface 222.

In one embodiment, first user interface 212 of first computing device 210 and second user interface 222 of second computing device 220 comprise a touch screens. Additionally, or alternatively, first computing device 210 and second computing device 220 may include one or more other input mechanisms, including, but not limited to, a keyboard, a pointing device, a mouse, a stylus, a touch sensitive panel (e.g., a touch pad or a touch screen), a camera, a gyroscope, an accelerometer, a position detector, and/or an audio input device.

In one embodiment, first computing device 210 is configured to enable a user to input information and/or display information relevant to the user. For example, in the embodiment illustrated in FIG. 2A, first user interface 212 includes a prompt for a customer to enter their phone number 214 (“Enter Phone Number for Rewards”). Additionally, or alternatively, first user interface 212 may include a prompt for a customer to enter any other unique identifier, such as a loyalty program username or number. In the embodiment illustrated in FIG. 2A, first user interface 212 comprises a touch screen and includes numerical virtual buttons 216 to enable a customer to input their phone number or other unique identifier. Additionally, or alternatively, first user interface 212 may include alphabetic virtual buttons.

Second user interface 222 of second computing device 220 is configured to display information relevant to retail workers and/or enable retail workers to input relevant information. For example, in the embodiment illustrated in FIG. 2B, second user interface 222 includes a goal information display 224 which includes goal information “New Members Goal: 200” and “We are 50 members short!”. Additionally or alternatively, second user interface 222 may display various other information relevant to retail workers, such as remainders for retail workers. For example, in the embodiment illustrated in FIG. 2B, second user interface 222 includes remainder 226 that “It's almost 4 pm, please remember to complete your shift change checklist”. Additionally, or alternatively, second user interface 222 may include any other information relevant to retail workers, such as the time remaining until a store closes or until a shift ends (e.g., “You have 2 hours and 30 minutes remaining to sign up 50 members and achieve new member signup goal”), goal information for a specific employee (e.g., “You need to sign up 5 additional members to achieve your personal new member signup goal”), information regarding a specific transaction (“Remind customer they will earn 100 loyalty points if they purchase a soda”). Additionally, or alternatively, second user interface 222 may display information to the retailer worker about a customer standing across from them during a transaction and/or one or more suggestions. For example, second user interface 222 may include a name associated with a unique consumer identifier inputted during a transaction and information about the customer, such as the number of loyalty points they have in their account, offers that are available to the customer, and/or suggested dialogue to the customer (e.g., “Reminder customer they will receive a 50% discount if they purchase two H20 water bottles”).

In some embodiments, second computing device 220 is configured to enable a retailer work or other use to input information. For example, second user interface 222 may include a prompt for a retail worker to input their phone number or any other unique identifier (e.g., a loyalty account username or number). This may enable second user interface 222 to display information specific to a particular retail worker (e.g., “You need to sign up 5 additional members to achieve your personal new member signup goal”). Additionally, or alternatively, second user interface 222 may include a prompt for a retail worker or other user to input a unique identifier for a particular store or group of stores (e.g., a store ID associated with one or more stores). This may enable second user interface 222 to display information specific to a particular store (e.g., “Main Street Store is 50 members short of its new member goal”) or a group of stores (e.g., “Mayberry Stores are 100 members short of their new member goal”). For example, second user interface 222 may comprise a touch screen which includes numerical and/or alphabetic virtual buttons.

In the embodiment illustrated in FIGS. 2A-2C, first computing device 210 and second computing device 220 are mounted or otherwise attached to a single base 230. However, first computing device 210 and second computing device 220 may be mounted or otherwise attached to separate bases.

In one embodiment, first computing device 210 and second computing device 220 each include mechanisms for adjusting a height, an angle, and/or location of the respective computing device so a user may have optimal access to the respective computing device. The mechanisms for adjusting the height, angle, and/or location of the first computing device 210 and second computing device 220 may be any adjustment mechanism known in the art.

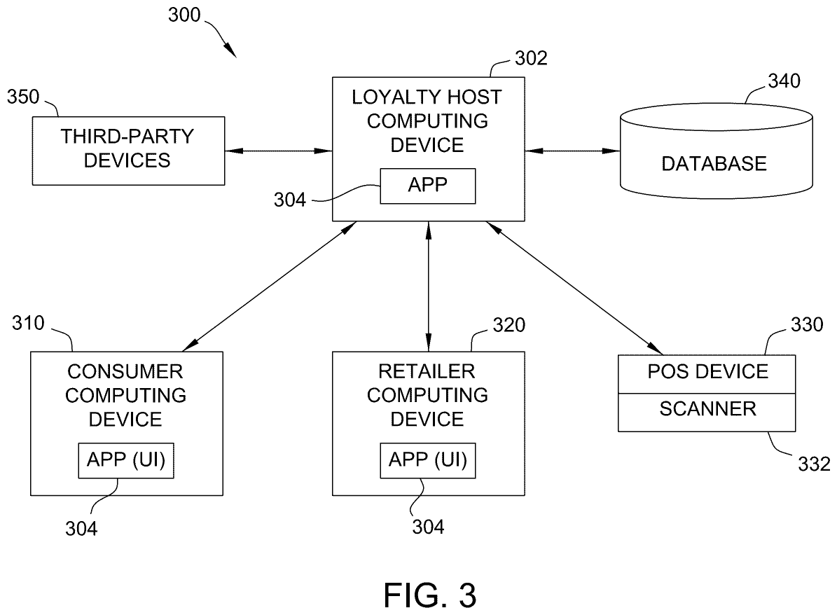

FIG. 3 depicts a block diagram of a loyalty host computing system 300. Loyalty host computing system 300 is configured to create and maintain a loyalty program. More particularly, loyalty host computing system 300 is configured to generate dynamic and intelligent offerings for a particular customer which are responsive to transaction data, user profile data, and/or other relevant data and. Loyalty host computing system 300 is further configured to present such offerings to customers during a transaction or other relevant time and automatically apply such offerings to relevant transactions involving the particular customer.

Further, loyalty host computing system 300 is configured to present relevant data about a particular customer during a transaction to a retail worker. Additionally, or alternatively, loyalty host computing system 300 is configured to generate dynamic and intelligent goals for retailer workers and/or stores and track and update such goals. Loyalty host computing system 300 is further configured to present such goals and updates to retail workers in real-time.

In one embodiment, loyalty host computing system 300 may include and/or facilitate communication between one or more computing devices. For example, loyalty host computing system 300 may include and/or facilitate communication between a loyalty host computing device 302, a consumer computing device 310, a retailer computing device 320, a point-of-sale (POS) device 330. In one embodiment, POS device 330 includes a scanner 332 and/or is communicatively coupled to scanner 332. In one embodiment, loyalty host computing device 302 is communicatively coupled to one or more third-party devices 350. Additionally or alternatively, loyalty host computing device 302 may be further communicatively coupled to one or more servers (not shown) and/or one or more user computing devices (not shown). Consumer computing device 310 and retailer computing device 320 may be physically and/or communicatively coupled together. For example, consumer computing device 310 and retailer computing device 320 may comprise a dual display device, such as dual display device 200 illustrated in FIGS. 2A-2C.

Loyalty host connect computing device 302 may be implemented as a server computing device. In one embodiment, loyalty host computing device 302 may be implemented as a server computing device with artificial intelligence (AI) and deep learning (DL) functionality. Additionally, or alternatively, loyalty host computing device 302 may be implemented as any device capable of interconnecting to the Internet, including mobile computing device or “mobile device,” such as a smartphone, a “phablet,” or other web-connectable equipment or mobile devices (such as one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice or chat bots, ChatGPT bots, and/or other electronic or electrical components, which may be in wired or wireless communication with one another).

In one embodiment, loyalty host computing device 302 may be in communication with consumer computing device 310, retailer computing device 320, and/or POS device 330 via wireless communication or data transmission over one or more radio frequency links or wireless communication channels. In one embodiment, components of loyalty host computing system 300 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular telecommunications connection (e.g., a 3G, 4G, 5G, etc., connection), a cable modem, and a BLUETOOTH connection.

Loyalty host computing system 300 also includes one or more databases 340 containing information on a variety of matters. For example, database 340 may include such information as retailer and user authentication and authorization data, retailer location data, and/or any other information used, received, and/or generated by loyalty host computing system 300 and/or any component thereof, including such information as described herein. In one embodiment, database 340 may include a cloud storage device, such that information stored thereon may be securely stored but still accessed by one or more components of loyalty host computing system 300, such as, for example, consumer computing device 310, retailer computing device 320, and/or POS device 330. In one embodiment, database 340 may be stored on loyalty host computing device 302. Additionally, or alternatively, database 340 may be stored remotely from loyalty host computing device 302 and may be non-centralized.

In one embodiment, consumer computing device 310 and/or retailer computing device 320 may be computers that include a web browser or a software application to enable consumer computing device 310 and/or retailer computing device 320 to access to functionality of loyalty host computing device 302 using the Internet or a dial connection, such as a cellular network connection. Consumer computing device 310 and/or retailer computing device 320 may be any device capable of accessing the Internet including, but not limited to, a desktop computer, a mobile device (e.g., a laptop computer, a personal digital assistant (PDA), a cellular phone, a smartphone, a tablet, a phablet, netbook, notebook, smart watches or bracelets, smart glasses, wearable electronics, pagers, virtual reality headsets, augmented reality glasses, voice or chat bots, wearables, etc.), or other web-based connectable equipment.

Consumer computing device 310 and retailer computing device 320 are used access a loyalty app 304 maintained by loyalty host computing device 302, for example, via a user interface of the respective computing device when loyalty app 304 is executed on user computing device 108. A user may use loyalty app 304 to provide inputs to loyalty app 304, change preferences, and perform other actions, including those described elsewhere herein.

Loyalty hosting computing device 302 generates consumer-specific offerings, such as incentives, and the like, to affect or influence user behavior. More particularly loyalty host computing device 302 generates consumer-specific offerings and presents such offerings to the consumer during a transaction via consumer computing device 310.

Third party devices 350 may be computing devices associated with external sources of data. Loyalty host computing device 302 may request, receive, and/or otherwise access data from third party devices 350. Third party devices 350 may be any devices capable of interconnecting to the Internet, including a server computing device, a mobile computing device or “mobile device,” such as a smartphone, or other web-connectable equipment or mobile devices.

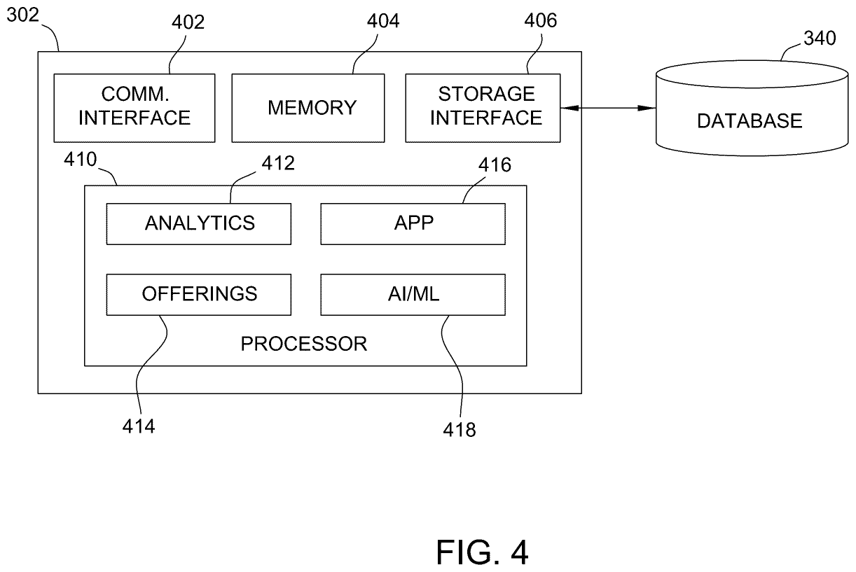

FIG. 4 depicts loyalty host computing device 302 (as shown in FIG. 3). In one embodiment, loyalty host computing device 302 includes a communication interface 402, a memory 404, a storage interface 406, and a processor 410. Processor 410 is configured to execute instructions, which may be stored in memory 404. Processor 410 includes one or more processing units (e.g., in a multi-core configuration) and may be configured to execute a plurality of modules.

In some embodiments, processor 410 is operable to execute an analytics module 412, an offerings module 414, a module 416 that maintains functionality for loyalty app 304 (shown in FIG. 3), and/or an artificial intelligence/machine learning (AI/ML) module 418. Modules 412, 414, 416, and 418 may include specialized instruction sets, and/or coprocessors. Database 340 and/or memory 404 may store any data and/or instructions necessary for modules 412, 414, 416, and 418 to function as described herein.

AI/ML module 418 may execute artificial intelligence and/or deep learning functionality on behalf of analytics module 412 and/or offerings module 414. Specifically, AI/DL module 418 may include any rules, algorithms, training data sets/programs, and/or any other suitable data and/or executable instructions that enable loyalty host computing device 302 to employ artificial intelligence and/or deep learning to analyze data to generate offers and provide performance data insights, as discussed in more detail below.

Analytics module 412 is configured to track data. More particularly, analytics module 412 may be configured to track data related to performance of offerings, retail goals, and the like. In one embodiment, analytics module 412 is further configured to make predictions. For example, in one embodiment, analytics module 412 utilizes one or more algorithms to identify patterns and trends in transaction data and/or retail performance data and to make one or more predictions. For example, in one embodiment, analytics module 412 may apply one or more algorithms to predict whether a retail site, a group of retail sites, and/or a particular retail worker will meet one or more performance goals. In one embodiment, analytics module 412 leverages AI/DL to identify patterns and trends, make predictions, and generate dialogue. For example in one embodiment, analytics module 412 applies transaction data, user profile data, and/or available offer data to generate suggested dialogue for a retail worker, to be displayed on a retailer computing device (e.g. retailer computing device 320).

Offerings module 414 is configured to generate offers. The offers generated by offerings module 414 may be offers available to all users who belong to the loyalty program and/or may be customized for a particular user or a group of users who belong to the loyalty program. Offerings module 414 may generate and/or transmit offerings in real-time. In one embodiment, offerings module 414 may transmit the offering to one or more users in the form of an alert (e.g., within loyalty app 304 shown in FIG. 3, a text message, and/or a pop-up or push notification). Offerings module 414 may be further configured to track transaction data associated with one or more offerings, as discussed in more detail below. Offerings module 414 may be configured to receive this transaction data directly or indirectly from a merchant computing device (e.g., POS device 330 shown in FIG. 3), a third-party device (e.g., third-party device 350 shown in FIG. 3), a database (e.g., database 340 shown in FIGS. 3 and 4), or any other storage or computing device. In one embodiment, the transaction data is dynamically updated in real-time. This transaction data may then be processed, analyzed, and visualized, as discussed in more detail below. In one embodiment, offerings module 414 may apply one or more algorithms to predict whether an offering will result in additional sales. In one embodiment, offerings module 414 leverages AI/DL to identify patterns and trends and make predictions.

App module 416 is configured to facilitate maintaining loyalty app 304 (shown in FIG. 3) and providing the functionality thereof to users. App module 416 may store instructions that enable download and/or execution of loyalty app 304 at consumer computing device 310 (shown in FIG. 3), retailer computing device 320 (shown in FIG. 3), a user computing device, third-party device 350 (shown in FIG. 3), and/or any other computing device. App module 416 may store instructions regarding user interfaces, offerings, conditions, and the like, into a format suitable for transmitting to a computing device for display thereof.

In one embodiment, processor 410 is operatively coupled to communication interface 402 such that loyalty host computing device 403 is capable of communicating with remote devices, such as consumer computing device 310 (shown in FIG. 3), retailer computing device 320 (shown in FIG. 3), a user computing device, third-party device 350 (shown in FIG. 3), and/or any other computing device, and the like, over a wired or wireless connection. For example, loyalty host computing device 302 may receive transaction data from one or more merchant computing devices (e.g., POS device 330 shown in FIG. 3) and consumer information from consumer computing device 310 and/or a user computing device. Communication interface 402 may include, for example, a wired or wireless network adapter and/or a wireless data transceiver for use with a mobile telecommunications network.

Processor 410 may also be operatively coupled to database 340 and/or any other storage device via storage interface 406. Database 340 may be any computer-operated hardware suitable for storing and/or retrieving data. In some embodiments, database 340 may be integrated in loyalty host computing device 302.

Offerings module 414 may transmit one or more offers to consumer computing device 310. Additionally, or alternatively, offering module 414 may transmit the user offering to a user computing device via a pop-up or push-notification, through a text message, e-mail, and/or the like. For example, loyalty host computing device 302 may include one or more hard disk drives as database 340. In other embodiments, database 340 is external to loyalty host computing device 302 and is accessed by a plurality of computer devices. For example, database 340 may include a storage area network (SAN), a network attached storage (NAS) system, multiple storage units such as hard disks and/or solid-state disks in a redundant array of inexpensive disks (RAID) configuration, cloud storage devices, and/or any other suitable storage device.

Storage interface 406 may be any component capable of providing processor 410 with access to database 340. Storage interface 406 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 410 with access to database 340.

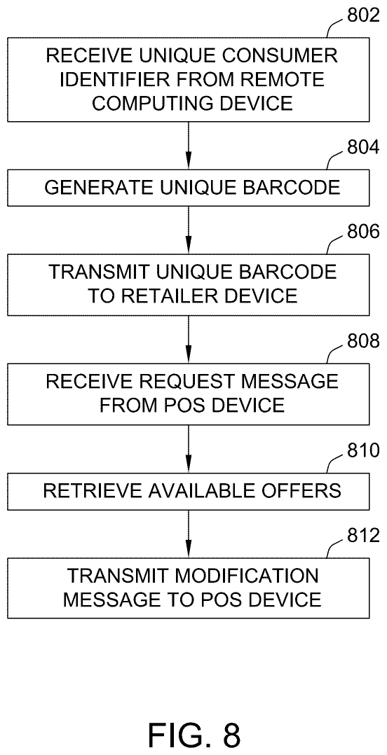

Processor 410 may execute computer-executable instructions for implementing aspects of the disclosure. In some embodiments, processor 410 may be transformed into a special purpose microprocessor by executing computer-executable instructions or by otherwise being programmed. For example, processor 410 may be programmed with the instructions such as those illustrated in FIG. 8.

Memory 404 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are example only, and are thus not limiting as to the types of memory usable for storage of a computer program.

In one embodiment, loyalty host computing device 302 may also maintain retailer connect software application or “app” 304 which links transactions to one or more unique identifiers associated with a consumer and/or a retail worker. App 304 enables consumers to view loyalty information, such as the number of loyalty points currently associated with their account, available offers, customized offers, and the like, during a transaction. Additionally and/or alternatively, app 304 enables retail workers to view performance data, such as whether a particular store goal has been met, reminders, and the like. Loyalty app 304 may be executed on consumer computing device 310 and/or retailer computing device 320 as described elsewhere herein.

In one embodiment, loyalty host computing device 302 enables a user to view transaction data, employee performance data, and/or additional or alternative data collected by consumer computing device 310, retailer computing device 320, POS device 330, third party devices 350, and/or other data transmitted to loyalty host computing device 302.

In one embodiment, loyalty host computing device 302 further includes AI/ML module 418. AI/ML 418 module may execute artificial intelligence and/or deep learning functionality. Specifically, AI/ML 418 module may include any rules, algorithms, training data sets/programs, and/or any other suitable data and/or executable instructions that enable loyalty host computing device 302 to employ artificial intelligence and/or deep learning to generate user profiles, consumer offerings, employee offerings, to make predictions, and the like.

In one embodiment, AI/ML 418 module applies current transaction data, unique consumer identifier data, and/or user profile data to a trained machine-learning model to generate one or more offers. In this way, a custom offer may be generated for a particular user. The trained machine-learning model may be trained on historical transaction data, historical consumer identifier data, historical profile data, and/or historical offer data. Loyalty host computing device 302 may track whether an offer was successful for not. For example, POS device 330 may transmit transaction data to loyalty host computing device 330 and the loyalty host computing device 302 may determine whether the offer resulted in an increase in the amount purchase. The historical transaction data is updated to include the current transaction data and the historical offer data is included the include the current offer data, and the trained machine-learning model is re-trained using the updated historical data. Similarly, AI/ML 418 module applies historical transaction data, unique consumer identifier data, and/or user profile data to a trained machine-learning model to generate suggested dialogue for a retail worker. In this way, loyalty host computing device 302 can provide suggested dialogue to a retailer worker via a retailer computing device (e.g., retailer computing device 320 shown in FIG. 3). The suggested dialogue may be customized for the customer standing across from the retail worker during a transaction. For example, the suggested dialogue may include a name of the customer standing across from the retail worker during a transaction and language shown to be persuasive in encouraging a customer to perform a specific action (e.g., sign up for a program, buy additional items to receive a discount, etc.).

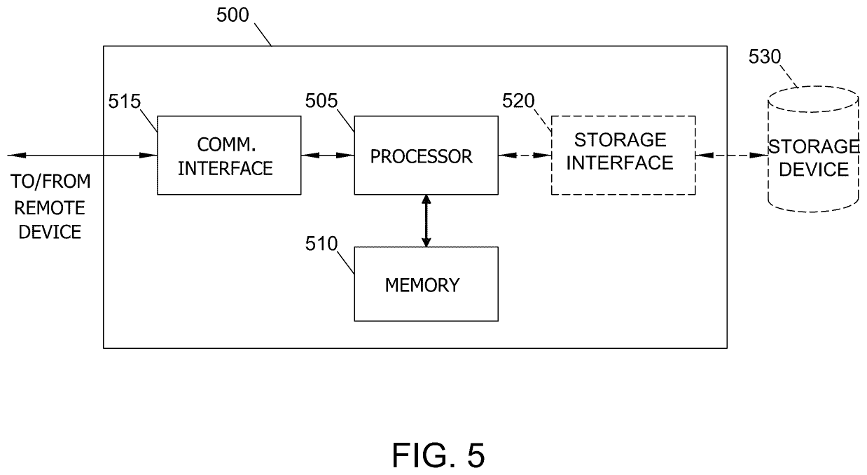

FIG. 5 is a schematic diagram of an example configuration of a server computing device 500, in accordance with some embodiments of the present disclosure. Server computing devices having an architecture similar to server computing device 500 may be used to implement one or more of the computing systems shown in FIG. 3. In the example embodiment, server computing device 500 includes processor 505 for executing instructions (not shown) stored in a memory 510. In an embodiment, processor 505 may include one or more processing units (e.g., in a multi-core configuration). The instructions may be executed within various different operating systems, such as UNIX®, LINUX® (LINUX is a registered trademark of Linus Torvalds), Microsoft Windows®, etc. It should also be appreciated that upon initiation of a computer-based method, various instructions may be executed during initialization. Some operations may be required in order to perform one or more processes described herein, while other operations may be more general or specific to a particular programming language (e.g., C, C#, C++, Java, or other suitable programming languages, etc.).

In the example embodiment, processor 505 is operatively coupled to a communication interface 515 such that server computing device 500 is capable of communicating with a remote device, such as a user or system administrator computing system (not shown) or another server computing device 500.

In the example embodiment, processor 505 is also operatively coupled to a storage device 530, which may be, for example, a computer-operated hardware unit suitable for storing or retrieving data. In some embodiments, storage device 530 is integrated into server computing device 500. For example, server computing device 500 may include one or more hard disk drives as storage device 530. In other embodiments, storage device 530 is external to server computing device 500 and may be accessed by a plurality of server computing devices 500. For example, storage device 530 may include multiple storage units such as hard disks or solid-state disks in a redundant array of inexpensive disks (RAID) configuration. Storage device 530 may include a storage area network (SAN) or a network attached storage (NAS) system. Storage device 530 may be used as a repository for one or more databases or other data structures for storing various data elements received, processed, and/or generated by loyalty host computing device 302 and/or any other computing device discussed herein.

In some embodiments, processor 505 is operatively coupled to storage device 530 via an optional storage interface 520. Storage interface 520 may include, for example, a component capable of providing processor 505 with access to storage device 530. In an exemplary embodiment, storage interface 520 further includes one or more of an Advanced Technology Attachment (ATA) adapter, a Serial ATA (SATA) adapter, a Small Computer System Interface (SCSI) adapter, a RAID controller, a SAN adapter, a network adapter, or a similarly capable component providing processor 505 with access to storage device 530.

Memory area 510 may include, but is not limited to, random-access memory (RAM) such as dynamic RAM (DRAM) or static RAM (SRAM), read-only memory (ROM), erasable programmable read-only memory (EPROM), electrically erasable programmable read-only memory (EEPROM), non-volatile RAM (NVRAM), and magneto-resistive random-access memory (MRAM). The above memory types are for example only, and are thus not limiting as to the types of memory usable for storage of a computer program.

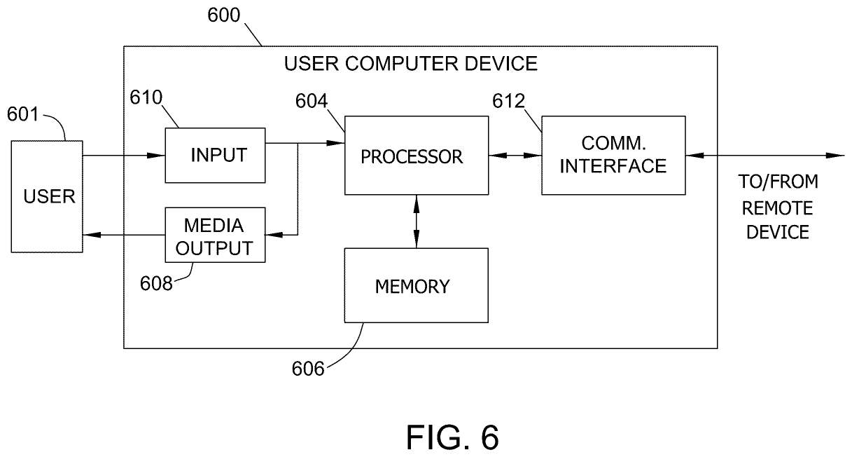

FIG. 6 illustrates an example configuration of a user computing device 600. User computing device 600 includes a processor 604 for executing instructions. In some embodiments, executable instructions are stored in a memory area 606. Processor 604 may include one or more processing units (e.g., in a multi-core configuration). Memory area 606 is any device allowing information such as executable instructions and/or other data to be stored and retrieved. Memory area 606 may include one or more computer-readable media.

User computing device 600 also includes at least one media output component 608 for presenting information to a user. Media output component 608 is any component capable of conveying information to user. In some embodiments, media output component 608 includes an output adapter such as a video adapter and/or an audio adapter. An output adapter is operatively coupled to processor 604 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones). For example, an account holder may view their payment account and posted amounts on their payment account via media output component 608.

In some embodiments, user computing device 600 includes an input device 610 for receiving input from user. Input device 610 may include, for example, a keyboard, a pointing device, a mouse, a stylus, a touch sensitive panel (e.g., a touch pad or a touch screen), a camera, a gyroscope, an accelerometer, a position detector, and/or an audio input device. A single component such as a touch screen may function as both an output device of media output component 608 and input device 610.

User computing device 600 may also include a communication interface 612, which is communicatively couplable to a remote device such as a server system or a web server operated by a merchant. Communication interface 612 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

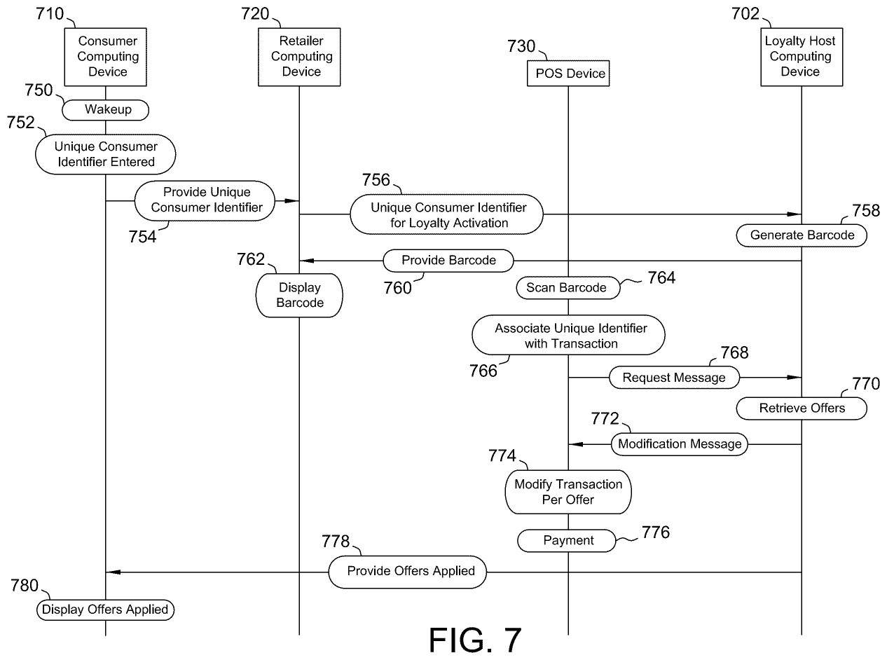

FIG. 7 is a protocol diagram that depicts a protocol sequence for associating a transaction with a unique consumer identifier and applying a reward to the transaction in accordance with an embodiment of the present disclosure. More particularly, FIG. 7 illustrates a protocol sequence between a consumer computing device 710, a retailer computing device 720, a POS device 730, and a loyalty host server 702.

At 750, consumer computing device 710 wakes up. Consumer computing device 710 may wake up in response to a user approaching consumer computing device 710, a user touching a screen of consumer computing device 710, and/or the like. A user, such as a consumer, inputs, via the consumer computing device 710, a unique consumer identifier. The unique consumer identifier comprises a phone number, a loyalty username or number, or any other unique identifier. The unique consumer identifier is transmitted from consumer computing device 710 to retailer computing device 720 at 754. Retailer computing device 720 then transmits the unique consumer identifier to loyalty host computing device 702 at 754 for loyalty activation. Loyalty host computing device 702 then generates a barcode at 758 and transmits the bar code to retailer computing device 720 at 760. Retailer computing device 720 then displays barcode on a user interface of retailer computing device 720 at 762. In one embodiment, the barcode is displayed as a popup on the user interface of retailer computing device 720. In one embodiment, the barcode is a unique barcode which is associated with the consumer identifier. In one embodiment, the barcode comprises a linear barcode, a two-dimensional barcode, and/or a two-dimensional matrix barcode (e.g., a QR code). The unique barcode includes machine-readable data. The machine-readable data includes the unique consumer identifier.

POS device 730 scans the barcode at 764. In one embodiment, POS device 730 includes a scanner which is used to scan the barcode. In one embodiment, the scanner is a barcode scanner (e.g., a scanner with a photosensor). Additionally, or alternatively, the scanner comprises a camera (e.g., a smartphone camera) which is configured to read a barcode (e.g., a QR code). After POS device 730 scans the barcode, POS device 830 associates the unique consumer identifier contained in the barcode data with the transaction at 766.

Next, POS device 730 transmits a transaction information message to loyalty host computer device 702 at 768. The request message includes a request for an offer for the transaction and the unique consumer identifier. In one embodiment, the request message further includes transaction data associated with the current transaction. For example, the request message may include a transaction amount (e.g., a total for the transaction) and/or data regarding the items purchased (e.g., the type of items purchased, the specific items purchased, the quantity of each item purchased, the cost of one or more of the items purchased, and the like). Loyalty host computing device 702 uses the data contained in the request message to retrieve one or more available offers at 770. For example, loyalty host computing device 702 uses the unique consumer identifier to retrieve one or more available offers associated with the unique consumer identifier. In one embodiment, loyalty host computing device 702 performs a lookup of the unique consumer identifier in a database. The database may contain data regarding unique consumer identifiers and a user profile associated therewith. If a unique consumer identifier is not found in the database, a user profile may be automatically generated for the consumer identifier, as described in U.S. application Ser. No. 18/174,434, filed Feb. 24, 2023, entitled “WALLET STEERING: SYSTEM, ENGINE, METHOD, AND PROFESSIONAL SERVICES TO PROGRAMMATICALLY, PRECISELY, AND PROFITABLY STEER CONSUMER PURCHASES FROM ONE BUSINESS TO ANOTHER AND/OR ONE PRODUCT/SERVICE TO ANOTHER”, and U.S. application Ser. No. 18/735,906, filed Jun. 6, 2024, entitled “SYSTEMS AND METHODS FOR TRANSFORMATION AND MANAGEMENT OF DATA WITHIN A CONFIGURABLE NETWORK”, the entire contents and disclosures of which are hereby incorporated by reference in their entirety.

The one or more available offers may be offers which are stored in a user profile associated with the unique consumer identifier and/or offers which are customized for the unique consumer identifier based on current transaction and/or prior transaction data. For example, the offers may be generated using the systems and methods disclosed in U.S. application Ser. No. 18/174,434, filed Feb. 24, 2023, entitled “WALLET STEERING: SYSTEM, ENGINE, METHOD, AND PROFESSIONAL SERVICES TO PROGRAMMATICALLY, PRECISELY, AND PROFITABLY STEER CONSUMER PURCHASES FROM ONE BUSINESS TO ANOTHER AND/OR ONE PRODUCT/SERVICE TO ANOTHER”, and U.S. application Ser. No. 18/735,906, filed Jun. 6, 2024, entitled “SYSTEMS AND METHODS FOR TRANSFORMATION AND MANAGEMENT OF DATA WITHIN A CONFIGURABLE NETWORK”, the entire contents and disclosures of which are hereby incorporated by reference in their entirety. In one embodiment, transaction data is used to determine whether an offer is applicable, and therefore available to be used in a transaction.

In one embodiment, loyalty host computing device 702 transmits relevant data to retailer computing device 720. For example, in one embodiment, loyalty host computing device 702 transmits a name associated with the unique consumer identifier, at least one offer available to the customer, suggested dialogue for a retail worker to the customer, and any other relevant data, to be displayed on a user interface of retailer computing device 720.

Next, at 774 a modification message is transmitted to POS device 730. In one embodiment, the modification message is transmitted to POS device 730 in response to one or more conditions being met. In one embodiment, the modification message is transmitted if POS device 730 reports an increase in the total transaction amount to loyalty host computing device 702. For example, if an offer is displayed on customer-facing device and/or retailer-facing device, and the offer results in the customer purchasing another item after the offer is displayed, the modification message is transmitted to POS device 730. In one embodiment, the modification message is transmitted if one or more conditions presented in one or more offers displayed on the customer-facing device and/or the retailer-facing device is met. For example, if an offer displayed on customer-facing device is $1 off the total transaction amount if the customer purchases two H20 waters, the modification message is sent if the customer purchases two H20 waters. The modification message includes instructions to modify the transaction according to the one or more offers. POS device 730 modifies the transaction according to the one or more offers at 772. Next, at 776, payment is tendered for the transaction. Loyalty host computing device 702 provides the offers applied to the transaction to consumer computing device 710 at 778. Consumer computing device 710 then displays the offers applied on a user interface of consumer computing device 710 at 780. In one embodiment, the process further includes storing the transaction data, including the offers applied, in the user profile associated with the unique consumer identifier.

FIG. 8 is a flow diagram illustrating a process 800 of an interactive loyalty program in accordance with an embodiment of the present disclosure. Process 800 may be executed by at least one processor. For example, process may be executed by processor 410 of loyalty host computing device 302 (shown in FIG. 4). At 802, a unique consumer identifier is received from a remote computing device, such as retailer computing device 320 and/or consumer computing device 310 (shown in FIG. 3). Next, at 804, a unique barcode is generated. The unique barcode contains machine-readable data, the machine-readable data including the unique consumer identifier. The unique barcode is transmitted to a retailer computing device (e.g., retailer computing device 320 shown in FIG. 3).

Next, at 808, a request message is received from the POS device. The request message includes a request for an offer for the transaction and the unique consumer identifier. In one embodiment, the request message further includes transaction data associated with the current transaction. For example, the request message may include data regarding the items purchased (e.g., the type of items purchased, the specific items purchased, the quantity of each item purchased, and the like).

All available offers associated with the unique consumer identifier are then retrieved at 810. Available offers may be stored in a database (e.g., database 340) which stores information regarding unique consumer identifiers and one or more offers associated with a unique consumer identifier and/or a user profile associated with a unique consumer identifier. In one embodiment, transaction data is used to only retrieve offers which are applicable to the current transaction being conducted. The offers may then be displayed on a customer-facing device and/or a retailer-facing device.

Next, a modification message is transmitted to the POS device at 812. The modification message includes instructions to modify the transaction according to the one or more available offers. In one embodiment, the modification message is transmitted to the POS device 812 on a condition that the transaction has been modified in some way. For example, if the offer is displayed on a customer-facing device and/or a retailer-facing device, and this results in the customer purchasing an additional item, a message is received from the POS device indicating the transaction amount has increased, which thereby causes the modification message to be sent.

In one embodiment, process 800 further comprises transmitting transmits relevant data to retailer computing device 720. For example, in one embodiment, process further includes transmitting a name associated with the unique consumer identifier, at least one offer available to the customer, suggested dialogue for a retail worker to the customer, and any other relevant data, to be displayed on a user interface of retailer computing device (e.g., retailer computing device 320 shown in FIG. 3). In one embodiment, process 800 further includes storing the transaction data, including the offers applied, in the user profile associated with the unique consumer identifier.

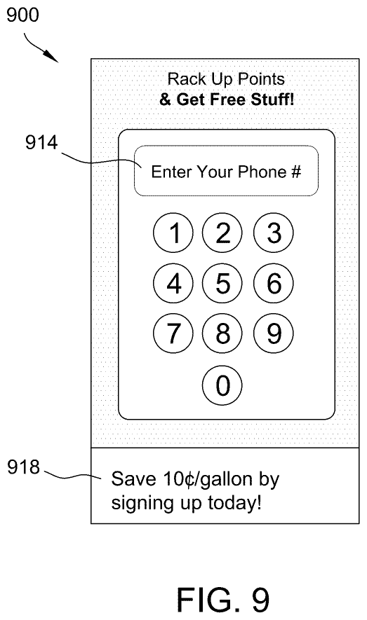

FIG. 9 illustrates a user interface 900 configured to be displayed on a customer computing device (e.g., consumer computing device 310 in FIG. 3) during a transaction in accordance with an embodiment of the present disclosure. User interface 900 enables a user to input information and/or display information relevant to the user. For example, in the embodiment illustrated in FIG. 9, user interface 900 includes a prompt for a customer to enter their phone number 914 (“Rack Up Points & Get Free Stuff”). Additionally, or alternatively, user interface 900 may include a prompt for a customer to enter any other unique identifier, such as a loyalty program username or number. In the embodiment illustrated in FIG. 9, user interface 900 comprises a touch screen and includes numerical virtual buttons 916 to enable a customer to input their phone number or other unique identifier. Additionally, or alternatively, user interface 900 may include alphabetic virtual buttons (not shown). User interface 900 further includes information regarding one or more offers 918 (e.g., “Save 10 cents/gallon by signing up today”).

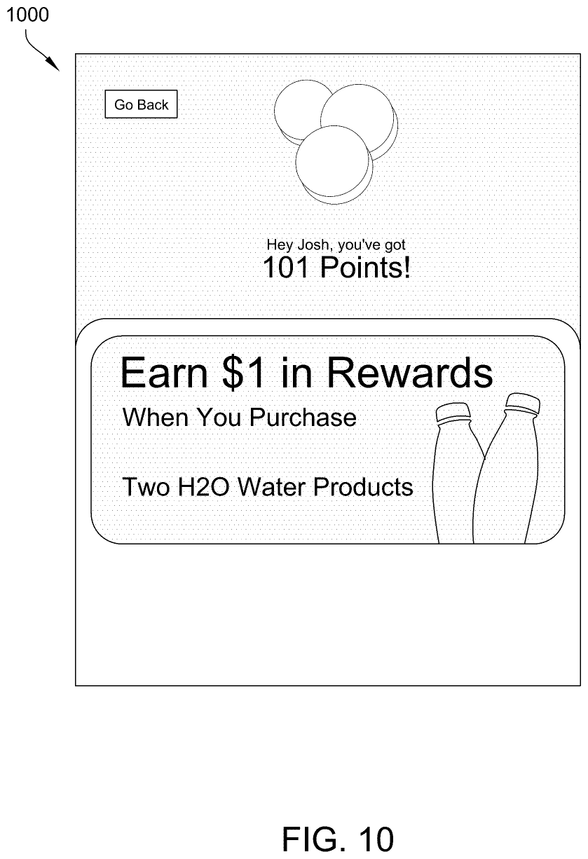

FIG. 10 illustrates another user interface 1000 for a customer computing device (e.g., consumer computing device 310 in FIG. 3) during a transaction in accordance with an embodiment of the present disclosure. User interface 1000 may be displayed after a user enters their unique consumer identifier. User interface 1000 displays information, offers, and the like, which are linked to the entered unique consumer identifier. For example, in the embodiment illustrated in FIG. 10, user interface 1000 displays the number of loyalty points associated with the unique consumer identifier (“Hey Josh, you've got 101 points!”). Further, in the embodiment illustrated in FIG. 10, user interface 1000 displays one or more offers available to the unique consumer identifier (“Earn $1 in Rewards When You Purchase Two H20 Water Products”).

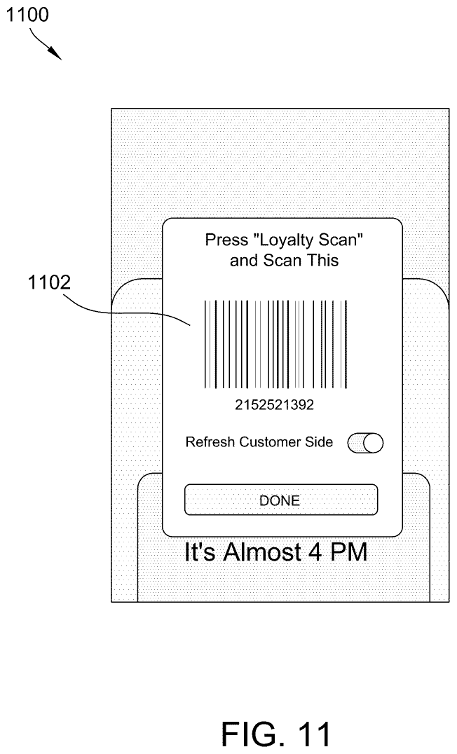

FIG. 11 illustrates a user interface 1100 for a retailer computing device (e.g., retailer computing device 320 in FIG. 3) during a transaction in accordance with an embodiment of the present disclosure. User interface 1100 may be displayed after a user enters their unique consumer identifier. User interface 1100 displays a unique barcode 1102 which is associated with the consumer identifier. Retailer computing device may receive the unique barcode from a loyalty host computing device (e.g. loyalty host computing device 302 shown in FIG. 3). A retailer worker can scan the unique barcode 1102 using a scanner of a POS system to associate a transaction with the unique consumer identifier. In this way, the loyalty host computing device can provide information and offers to a consumer associated with the unique consumer identifier, and collect data associated with the transaction to determine additional awards, loyalty points, offers, and the like, to associated with the unique consumer identifier.

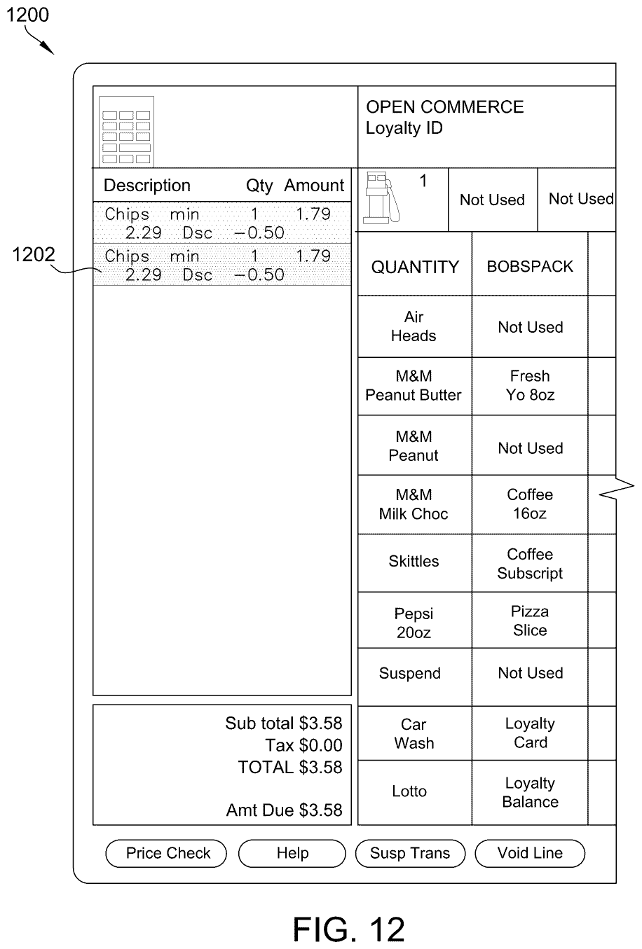

FIG. 12 illustrates a user interface 1200 for a POS device (e.g., POS device 330 in FIG. 3) during a transaction in accordance with an embodiment of the present disclosure. User interface 1200 is displayed after a unique consumer identifier has been associated with the transaction (e.g., after a consumer has entered their unique consumer identifier and a scanner of POS device has scanned a unique barcode associated with the unique consumer identifier) and one or more available offers have been received by loyalty host computer device. In the embodiment illustrated in FIG. 12, an offer is available for the transaction, the at least one offer comprising a discount on chips and this discount is reflected in the transaction data on user interface 1200 (“Disc −0.50” 1202).

In some embodiments, the transaction is not modified and the customers instead earns loyalty or reward points. For example, in one embodiment, a customer approaches a checkout counter at a retail location, where the checkout counter has a dual display device (e.g., dual display device 200 shown in FIGS. 2A-2C), in order to complete a transaction. In response to the consumer approaching the dial display device, a customer-facing device (e.g., first computing device 210 shown in FIGS. 2A-2C) may wakeup and display a user interface in which the customer can input their unique identifier, such as the customer's phone number, which is associated with a loyalty program user profile. If the customer's phone number is not associated with a loyalty program user profile, a loyalty program user profile may be generated for the customer. After the user enters their phone number, or other unique identifier (e.g., loyalty number or username), a loyalty host computing device (e.g., loyalty host computing device 302 shown in FIG. 3) communicatively coupled to the dual display device 200 generates a unique barcode for the customer and transmits the barcode to a retailer-facing device (e.g., second computing device 220 shown in FIGS. 2A-2C) which then displays the barcode. A retail worker can then scan the barcode using a scanner of the POS device (e.g., scanner 332 of POS device 330 shown in FIG. 3). By scanning the barcode, the retailer associates the transaction with the customer's loyalty program user profile. The retail worker then proceeds with the transaction as usual and scans products with the scanner. In this way, the customer-facing device and the retailer facing device can display information about the customer's loyalty program user profile and/or information relevant to the particular transaction. The customer-facing device can inform the customer about their current number of loyalty points they have and any offers available to them. For example, if the customer is purchasing an H20 water, the customer-facing device can inform the customer that they will earn 100 loyalty points if they another H20 water. The retailer-facing device can provide information to the retail worker about the customer. For example, the retailer-facing device can inform the retail worker that the customer is a frequent customer of the retail store and suggest the retail worker say “Welcome Back” to the customer. The retailer-facing device can also inform the retail worker about offers available to the customer. For example, the retailer-facing device can inform the retail worker that the customer will earn 100 loyalty points if they buy another H20 water during this transaction and suggest the retail worker remind the customer that the customer will earn 100 loyalty points if they buy another H20 water during this transaction. In response to the information displayed on the customer-facing device and/or provided by the retail worker, the customer then decides to purchase an additional H20 water. The customer brings an additional H20 water to the checkout counter, which the retail worker scans, thereby leading to an increase in the amount purchased. The loyalty host computing device recognizes that the customer has purchased the necessary number of H20 waters to earn the 100 loyalty points and updates the customer's loyalty program user profile to include an additional 100 loyalty points.

In other embodiments, the transaction is modified in accordance with offers stored in the customer's loyalty program user profile. For example, in one embodiment, a customer approaches a checkout counter at a retail location, where the checkout counter has a dual display device (e.g., dual display device 200 shown in FIGS. 2A-2C) t, in order to complete a transaction. In response to the consumer approaching the dial display device, a customer-facing device (e.g., first computing device 210 shown in FIGS. 2A-2C) may wakeup and display a user interface in which the customer can input their unique identifier, such as the customer's phone number, which is associated with a loyalty program user profile. If the customer's phone number is not associated with a loyalty program user profile, a loyalty program user profile may be generated for the customer. After the user enters their phone number, or other unique identifier (e.g., loyalty number or username), a loyalty host computing device (e.g., loyalty host computing device 302 shown in FIG. 3) communicatively coupled to the dual display device 200 generates a unique barcode for the customer and transmits the barcode to a retailer-facing device (e.g., second computing device 220 shown in FIGS. 2A-2C) which then displays the barcode. A retail worker can then scan the barcode using a scanner of the POS device (e.g., scanner 332 of POS device 330 shown in FIG. 3). By scanning the barcode, the retailer associates the transaction with the customer's loyalty program user profile. The retail worker then proceeds with the transaction as usual and scans products with the scanner. In this way, the customer-facing device and the retailer facing device can display information about the customer's loyalty program user profile and/or information relevant to the particular transaction. The customer-facing device can inform the customer about their current number of loyalty points they have and any offers available to them. For example, if the customer is purchasing an H20 water, the customer-facing device can inform the customer that they will receive a 50% discount on a bag of Crispy Chips if they purchase another H20 water. The retailer-facing device can provide information to the retail worker about the customer. For example, the retailer-facing device can inform the retail worker that the customer will receive a 50% discount on a bag of Crispy Chips of Crispy Chips if they purchase another H20 water during this transaction and suggest the retail worker remind the customer that the customer will receive 50% discount on a bag of Crispy Chips if they purchase another H20 water. In response to the information displayed on the customer-facing device and/or provided by the retail worker, the customer then decides to purchase an additional H20 water. The customer brings an additional H20 water and a bag of Crispy Chips to the checkout counter, which the retail worker scans, thereby leading to an increase in the amount purchased. The loyalty host computing device recognizes that the customer has purchased the necessary number of H20 waters to earn the 50% discount on the Crispy Chips, and the loyalty host computing device transmits a message to the POS device to modify the transaction to apply the 50% discount to the cost of the Crispy Chips. The loyalty host computing device can save this information to the customer's loyalty program user profile and this information can be used to generate future offers for this particular user and/or other users. For example, this information can be saved in a historical training dataset used to train a machine learning model which generates offers for users.

The computer-implemented methods discussed herein may include additional, less, or alternate actions, including those discussed elsewhere herein. The methods may be implemented via one or more local or remote processors, transceivers, and/or sensors (such as processors, transceivers, and/or sensors mounted on mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, a reinforced or reinforcement learning module or program, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample (e.g., training) data sets or certain data into the programs, such as conversation data of spoken conversations to be analyzed, mobile device data, and/or additional speech data. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing-either individually or in combination. The machine learning programs may also include natural language processing, semantic analysis, automatic reasoning, and/or other types of machine learning, such as deep learning, reinforced learning, or combined learning.

Supervised and unsupervised machine learning techniques may be used. In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. The unsupervised machine learning techniques may include clustering techniques, cluster analysis, anomaly detection techniques, multivariate data analysis, probability techniques, unsupervised quantum learning techniques, associate mining or associate rule mining techniques, and/or the use of neural networks. In some embodiments, semi-supervised learning techniques may be employed. In one embodiment, machine learning techniques may be used to extract data about the conversation, statement, utterance, spoken word, typed word, geolocation data, and/or other data.

In the exemplary embodiment, a processing element may be trained by providing it with a large sample of conversation data with known characteristics or features. Such information may include, for example, information associated with a plurality of different speaking styles and accents.

Based upon these analyses, the processing element may learn how to identify characteristics and patterns that may then be applied to analyzing conversation data. For example, the processing element may learn, with the user's permission or affirmative consent, to identify the most commonly used phrases and/or statement structures used by different individuals from different geolocations. The processing element may also learn how to identify attributes of different accents or sentence structures that make a user more or less likely to properly respond to inquiries. This information may be used to determine which how to prompt the user to answer questions and provide data.

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), SD card, memory device and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable medium. In an exemplary embodiment, the system is executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes. The present embodiments may enhance the functionality and functioning of computers and/or computer systems.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112 (f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A loyalty computing system comprising at least one processor and a memory device, the at least one processor configured to:
receive, from a point-of-sale (POS) device during a transaction, an offer request message, the offer request message including a unique consumer identifier and transaction data, the transaction data including a first transaction amount;
in response to receiving the offer request message, retrieve at least one offer associated with the unique consumer identifier;
cause to be displayed, on a user interface of a remote computing device, the at least one offer;
receive, from the POS device, updated transaction data, the updated transaction data including a second transaction amount that is greater than the first transaction amount;
in response to receiving the updated transaction data, transmit, to the POS device, a modification message, the modification message causing the POS device to modify the transaction in accordance with the at least one offer.

2. The loyalty computing system of claim 1, wherein the at least one processor is further configured to:
receive, from a consumer computing device during a transaction, a unique consumer identifier;
generate a unique barcode for the unique consumer identifier scannable by a scanner associated with the POS device; and
transmit, to a retail computing device, the unique barcode.

3. The loyalty computing system of claim 2, wherein the unique barcode includes the unique consumer identifier in a format readable by a scanner of the POS device.

4. The loyalty computing system of claim 1, wherein the at least one processor is further configured to perform a lookup in a database to determine a user profile associated with the unique consumer identifier.

5. The loyalty computing system of claim 4, wherein retrieving at least one offer comprises retrieving at least one offer stored in the user profile.

6. The loyalty computing system of claim 4, wherein the offer request message further includes transaction data associated with the transaction and wherein the at least one processor is further configured to store the transaction data in the user profile.

7. The loyalty computing system of claim 4, wherein the least one processor is configured to generate the at least one offer based on at least one of transaction data or data stored in the user profile.

8. A computer-implemented method for modifying transaction data at a remote point-of-sale (POS) device, the method implemented using a computing system including a processor communicatively coupled to a memory device, the computer-implemented method comprising:
receiving, from the POS device during a transaction, an offer request message, the offer request message including a unique consumer identifier and transaction data, the transaction data including a first transaction amount;
in response to receiving the offer request message, retrieving at least one offer associated with the unique consumer identifier;
causing to be displayed, on a user interface of a remote computing device, the at least one offer;
receiving, from the POS device, updated transaction data, the updated transaction data including a second transaction amount that is greater than the first transaction amount;
in response to receiving the updated transaction data, transmit, to the POS device, a modification message, the modification message causing the POS device to modify the transaction in accordance with the at least one offer.

9. The computer-implemented method of claim 8, further comprising:
receiving, from a consumer computing device during a transaction, a unique consumer identifier;
generating a unique barcode for the unique consumer identifier scannable by a scanner associated with the POS device; and
transmitting, to a retail computing device, the unique barcode.

10. The computer-implemented method of claim 9, wherein the unique barcode includes the unique consumer identifier in a format readable by a scanner of the POS device.

11. The computer-implemented method of claim 8, further comprising performing a lookup in a database to determine a user profile associated with the unique consumer identifier.

12. The computer-implemented method of claim 11, wherein retrieving at least one offer comprises retrieving at least one offer stored in the user profile.

13. The computer-implemented method of claim 11, wherein the offer request message further includes transaction data associated with the transaction and the computer-implemented method further comprising storing the transaction data in the user profile.

14. The computer-implemented method of claim 11, further comprising generating the at least one offer based on at least one of the transaction data or data stored in the user profile.

15. At least one non-transitory computer-readable medium comprising instructions stored thereon, the instructions executable by at least one processor to cause the at least one processor to perform steps including:
receive, from a point-of-sale (POS) device during a transaction, an offer request message, the offer request message including a unique consumer identifier and transaction data, the transaction data including a first transaction amount;
in response to receiving the offer request message, retrieve at least one offer associated with the unique consumer identifier;
cause to be displayed, on a user interface of a remote computing device, the at least one offer;
receive, from the POS device, updated transaction data, the updated transaction data including a second transaction amount that is greater than the first transaction amount;
in response to receiving the updated transaction data, transmit, to the POS device, a modification message, the modification message causing the POS device to modify the transaction in accordance with the at least one offer.

16. The at least one non-transitory computer-readable medium of claim 15, wherein the instructions further cause that at least one processor to:
receive, from a consumer computing device during a transaction, a unique consumer identifier;
generate a unique barcode for the unique consumer identifier scannable by a scanner associated with the POS device; and
transmit, to a retail computing device, the unique barcode.

17. The at least one non-transitory computer-readable medium of claim 15, wherein the instructions further cause that at least one processor to perform a lookup in a database to determine a user profile associated with the unique consumer identifier.

18. The at least one non-transitory computer-readable medium of claim 17, wherein retrieving at least one offer comprises retrieving at least one offer stored in the user profile.

19. The at least one non-transitory computer-readable medium of claim 17, wherein the offer request message further includes transaction data associated with the transaction and wherein the instructions further cause that at least one processor to store the transaction data in the user profile.

20. The at least one non-transitory computer-readable medium according of claim 17, wherein the instructions further cause that at least one processor to generate the at least one offer based on at least one of transaction data or data stored in the user profile.
